(19) United States
(12) Patent Application Publication
(10) Pub. No.: US 2026/0261815 A1
(43) Pub. Date: Sep. 3, 2026

(54) AUDIO APPARATUS AND METHOD OF OPERATION THEREFOR

(71) Applicant: KONINKLIJKE PHILIPS N.V., EINDHOVEN (NL)

(72) Inventor: Sam Martin Jelfs, Valkenswaard (NL)

(21) Appl. No.: 19/162,977

(22) PCT Filed: Mar. 4, 2024
(86) PCT No.: PCT/EP2024/055531

§ 371 Date: Sep. 8, 2025

(30) Foreign Application Priority Data
Mar. 20, 2023 (EP) 23162989.0

(51) Int. Cl. H04S 7/00; H04R 3/04

(52) U.S. Cl. CPC H04S 7/303; H04R 3/04

(57) ABSTRACT

An audio apparatus comprises a receiver (201) receiving an air flow audio frequency profile data indicating a dependency of an air flow audio frequency profile on an air flow velocity parameter. A frequency response generator (205) determines an air flow frequency response in dependence on the air flow audio frequency profile data, the user pose property, and an air flow velocity property for an air flow. An audio component generator (207) generates an air flow audio signal component by filtering the first audio signal using the air flow frequency response. An output (211) generates the audio signal to comprise the air flow audio signal component. The approach may provide an improved rendering of air flow sound, such as a more realistic rendering of wind noise.

### FIELD OF THE INVENTION

The invention relates to an audio apparatus and method of operation therefor, and in particular, but not exclusively, to an approach for generating an audio signal providing an improved representation of audio corresponding to air flow and wind noise in e.g. a virtual environment.

### BACKGROUND OF THE INVENTION

The variety and range of experiences based on audiovisual content have increased substantially in recent years with new services and ways of utilizing and consuming such content continuously being developed and introduced. In particular, many spatial and interactive services, applications and experiences are being developed to give users a more involved and immersive experience.

Examples of such applications are Virtual Reality (VR), Augmented Reality (AR), and Mixed Reality (MR) applications (commonly often referred to as extended Reality (XR)), which are rapidly becoming mainstream, with a number of solutions being aimed at the consumer market. A number of standards are also under development by a number of standardization bodies. Such standardization activities are actively developing standards for the various aspects of VR/AR/MR systems including e.g. streaming, broadcasting, rendering, etc.

VR applications tend to provide user experiences corresponding to the user being in a different world/environment/scene whereas AR (including Mixed Reality MR) applications tend to provide user experiences corresponding to the user being in the current environment but with additional information or virtual objects or information being added. Thus, VR applications tend to provide a fully immersive synthetically generated world/scene whereas AR applications tend to provide a partially synthetic world/scene which is overlaid the real scene in which the user is physically present. However, the terms are often used interchangeably and have a high degree of overlap. In the following, the term extended Reality/XR will be used to denote both Virtual Reality and Augmented/Mixed Reality.

As an example, a service being increasingly popular is the provision of images and audio in such a way that a user is able to actively and dynamically interact with the system to change parameters of the rendering such that this will adapt to movement and changes in the user's position and orientation. A very appealing feature in many applications is the ability to change the effective viewing position and viewing direction of the viewer, such as for example allowing the viewer to move and “look around” in the scene being presented.

Such a feature can specifically allow a virtual reality experience to be provided to a user. This may allow the user to (relatively) freely move about in a virtual environment and dynamically change his position and where he is looking. Typically, such virtual reality applications are based on a three-dimensional model of the scene with the model being dynamically evaluated to provide the specific requested view. This approach is well known from e.g. game applications, such as in the category of first person shooters, for computers and consoles.

It is also desirable, in particular for virtual reality applications, that the image being presented is a three-dimensional image, typically presented using a stereoscopic display. Indeed, in order to optimize immersion of the viewer, it is typically preferred for the user to experience the presented scene as a three-dimensional scene. Indeed, a virtual reality experience should preferably allow a user to select his/her own position, viewpoint, and moment in time relative to a virtual world.

In addition to the visual rendering, most XR applications further provide a corresponding audio experience. In many applications, the audio preferably provides a spatial audio experience where audio sources are perceived to arrive from positions that correspond to the positions of the corresponding objects in the visual scene. Thus, the audio and video scenes are preferably perceived to be consistent and with both providing a full spatial experience.

For example, many immersive experiences are provided by a virtual audio scene being generated by headphone reproduction using binaural audio rendering technology. In many scenarios, such headphone reproduction may be based on headtracking such that the rendering can be made responsive to the user's head movements, which highly increases the sense of immersion.

An important feature for many applications is that of how to generate and/or distribute audio that can provide a natural and realistic perception of the audio environment.

To create an immersive experience, it is desirable to render a complete audio scene with as close a resemblance of a realistic environment as possible. It is therefore desirable to not only render specific active audio sources, such as speakers or active sound generators, but to also render more subtle and more general audio sources such as various environmental or background audio sources. A specific example of such an audio component is air flow and wind noise in an environment. Various applications, such as games, have been developed that include a sound component corresponding to wind noise by rendering recorded wind noise audio. However, whereas this may provide a perception of such sounds to a user, it is typically not an optimal experience and typically it may be perceived as relatively artificial. This typically results in a less immersive experience to the user/listener.

Hence, an improved approach for rendering audio would be advantageous, and in particular an improved approach for rendering audio corresponding to air flow, such as in particular wind noise, would be advantageous. In particular, an approach that allows improved operation, increased flexibility, reduced complexity, facilitated implementation, an improved audio experience, improved audio quality, reduced computational burden, improved performance for virtual/mixed/augmented/extended reality applications, improved performance and user experience for gaming applications, improved adaptation to listener pose variations, increased immersiveness, increased and/or facilitated adaptability, and/or improved performance and/or operation would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an audio apparatus for generating an audio signal, the apparatus comprising: a receiver arranged to receive air flow audio frequency profile data indicating a dependency of an air flow audio frequency profile on an air flow velocity parameter; a pose determiner arranged to determine a listener pose property for a listener; a frequency response generator arranged to determine an air flow frequency response in dependence on the air flow audio frequency profile data, the user pose property, and an air flow velocity property for an air flow; an audio source arranged to provide a first audio signal; an audio component generator arranged to generate an air flow audio signal component, the generating comprising filtering the first audio signal using the air flow frequency response; and an output arranged to generate the audio signal to comprise the air flow audio signal component.

The approach may allow an improved audio experience in many embodiments, and may in many applications and scenarios provide a more immersive experience. In many scenarios an improved representation of air flow sounds, such as specifically wind noise, perceived by the listener may be achieved. Further, this may dynamically and flexibly be adapted to reflect changes in the listener pose thereby providing a more immersive and realistic effect to a listener. Further, the approach may allow an efficient generation of audio representing air flow with this being adapted to reflect user pose changes. It may in many scenarios have low computational resource requirements.

Further, in embodiments where the air flow audio frequency profile data is e.g. received from a remote source, the approach may be arranged to provide an advantageous audio under remote control/guidance while maintaining a low communication overhead.

The approach may allow an efficient content side control/assistance in the generation of air flow audio at the renderer/user side.

The air flow velocity parameter may comprise at least one of an air flow direction parameter and an air flow speed parameter. The air flow velocity parameter may be an air flow velocity parameter relative to a listener. The listener pose property may include at least one of a listener position parameter, listener orientation parameter, a listener position change parameter (such as specifically a listener velocity parameter), and a listener orientation change parameter. The listener pose may be a pose in the (coordinate system of) the audio scene being rendered.

A pose may be a position and/or orientation.

In accordance with an optional feature of the invention, the frequency response generator is arranged to generate the air flow frequency response in dependence on an air flow speed for the air flow relative to the listener.

This may provide improved performance and/or reduced complexity/resource demand. It may in many embodiments provide a particularly immersive and naturally sounding air flow sound. The frequency response generator may be arranged to determine the air flow speed in response to an air flow velocity parameter speed value for the air flow and a speed value of the listener pose.

In accordance with an optional feature of the invention, the frequency response generator is arranged to generate the air flow frequency response in dependence on an air flow direction for the air flow relative to the listener.

This may provide improved performance and/or reduced complexity/resource demand. It may in many embodiments provide a particularly immersive and naturally sounding air flow sound.

The frequency response generator may be arranged to determine the air flow direction in response to an air flow direction parameter value for the air flow and an orientation value of the listener pose.

In accordance with an optional feature of the invention, the first audio signal is a noise audio signal.

This may provide improved performance and/or reduced complexity/resource demand. It may allow a low complexity and facilitated implementation and/or reduced resource usage. A noise signal may be generated using a low complexity operation and a number of different algorithms with low resource usages are known and may be used. The noise audio signal may be generated dynamically during operation.

The audio source may consist in or comprise a pseudo-noise generator generating a pseudo-noise audio signal. The noise audio signal may be a stochastic signal. The noise audio signal may e.g. be a white noise or a pink noise audio signal.

In accordance with an optional feature of the invention, the audio component generator is arranged to generate the air flow audio signal component to be a stereo air flow audio signal component having a first channel and a second channel and the output is arranged to generate the audio signal to be a stereo audio signal with a first channel and a second channel.

This may provide improved user experience in many embodiments and may in particular provide an audio signal that provides a more natural sounding and immersive air flow sound. It may allow improved adaptation of the air flow sound to movement of the user including changing of head orientation. The first channel of the stereo air flow audio signal component and the first channel of the stereo audio signal may be a left channel and the second channel of the stereo air flow audio signal component and the second channel of the stereo audio signal may be a right channel. The output may be arranged to include the first channel signal component of the air flow audio signal component in the first channel of the stereo audio signal and to include the second channel signal component of the air flow audio signal component in the second channel of the stereo audio signal.

In accordance with an optional feature of the invention, the audio source is arranged to generate the first audio signal to be a stereo audio signal having different signals in the first channel and the second channel.

This may provide improved user experience in many embodiments and may in particular provide an audio signal that provides a more natural sounding and immersive air flow sound. It may allow improved adaptation of the air flow sound to movement of the listener including the listener changing head orientation. It may allow a computational and/or functionally efficient approach for generating an air flow noise/audio with suitable adaptability to head orientation and/or a suitable externalization. In accordance with an optional feature of the invention, the frequency response generator is arranged to generate the air flow frequency response to comprise a first air flow frequency response for the first channel and a second air flow frequency response for the second channel; and wherein the audio component generator is arranged to generate a first channel signal component for the air flow audio signal component using the first air flow frequency response for filtering and to generate a second channel signal component for the air flow audio signal component using the second air flow frequency response for filtering.

This may provide improved user experience in many embodiments and may in particular provide an audio signal that provides a more natural sounding and immersive air flow sound. It may allow improved adaptation of the air flow sound to movement of the user including changing of head orientation. It may allow a computationally and/or functionally efficient approach for generating an air flow noise with suitable adaptability to head orientation and/or a suitable externalization. The first and second air flow frequency response may be different for at least some values of the air flow property.

In accordance with an optional feature of the invention, the audio apparatus is arranged to generate the air flow audio signal component to have at least partly decorrelated signals for the first channel and the second channel.

This may provide improved user experience in many embodiments and may in particular provide an audio signal that provides a more natural sounding and immersive air flow sound. It may allow improved adaptation of the air flow sound to movement of the user including changing of head orientation. The approach may provide a degree of externalization of the air flow sound.

In accordance with an optional feature of the invention, the audio apparatus is arranged to adapt a degree of decorrelation between the first channel and the second channel of the stereo air flow audio signal component in dependence on an air flow direction for the air flow relative to the listener.

This may provide an improved user experience in many embodiments and may in particular provide an audio signal that provides a more naturally sounding and immersive air flow sound. It may allow improved adaptation of the air flow sound to movement of the user including changing of head orientation. The approach may provide a varying degree of externalization of the air flow sound.

In accordance with an optional feature of the invention, the air flow audio frequency profile data comprises an indication of a first dependency of a first air flow audio frequency profile on an air flow direction parameter and an indication of a second dependency of a second air flow audio frequency profile on an air flow speed parameter; and the frequency response generator is arranged to generate a first frequency response in response to the first dependency and an air flow direction for the air flow relative to the listener, to generate a second frequency response in response to the second dependency and an air flow speed for the air flow relative to the listener, and to generate the frequency response as a combination of the first frequency response and the second frequency response.

This may provide improved performance and/or reduced complexity/resource demand.

In accordance with an optional feature of the invention, the audio signal is a stored audio signal.

This may provide improved performance and/or reduced complexity/resource demand.

In accordance with an optional feature of the invention, the air flow audio frequency profile data comprises an indication of relative air flow audio frequency response values for each of a number of air flow velocity parameter values; and the frequency response generator is arranged to determine other relative air flow audio frequency response values for other values of the air flow velocity parameter by interpolation from the number of air flow velocity parameter values.

This may provide improved performance and/or reduced complexity/resource demand.

In accordance with an optional feature of the invention, the receiver is arranged to receive an indication of a property of an air flow source for the air flow and the frequency response generator is arranged to determine the air flow velocity property in response to the property of the air flow source.

This may provide improved performance and/or reduced complexity/resource demand. It may in many embodiments allow improved adaptation and may e.g. allow a low complexity and e.g. allow a characterization/adaptation of the air flow properties with a low communication overhead.

In accordance with an optional feature of the invention, the indication of a property of the air flow source is arranged to indicate the air flow source being at least one of the following: a global air flow source; an omnidirectional air flow source; a point air flow source; and a cone air flow source.

This may provide improved performance and/or reduced complexity/resource demand.

In accordance with an optional feature of the invention, the receiver is arranged to receive the indication of the property of the air flow source as part of metadata of an audio bitstream received from a remove source.

This may e.g. allow a characterization/adaptation of the air flow properties by a remote source with a low communication overhead.

According to an aspect of the invention there is provided a method of generating an audio signal, the method comprising: receiving air flow audio frequency profile data indicating a dependency of an air flow audio frequency profile on an air flow velocity parameter; determining a listener pose property for a listener; determining an air flow frequency response in dependence on the air flow audio frequency profile data, the user pose property, and an air flow velocity property for an air flow; providing a first audio signal; generating an air flow audio signal component, the generating comprising filtering the first audio signal using the air flow frequency response; and generating the audio signal to comprise the air flow audio signal component.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of elements of an extended Reality system;

FIG. 2 illustrates an example of an audio apparatus in accordance with some embodiments of the invention; and

FIG. 3 illustrates some elements of a possible arrangement of a processor for implementing elements of an audio apparatus in accordance with some embodiments of the invention.

### DETAILED DESCRIPTION OF SOME EMBODIMENTS OF THE INVENTION

The following description will focus on audio processing and rendering for an extended Reality (XR) application, such as for a Virtual Reality (VR), Augmented Reality (AR), or Mixed Reality (MR) application. The described approach will focus on such applications where audio rendering is adapted to reflect acoustic variations and changes in the audio perception of air flow audio as a (possibly virtual) user/listener pose may vary. However, it will be appreciated that the described principles and concepts may be used in many other applications and embodiments, including for example gaming applications where a virtual gaming world is presented as a spatial audio signal on a two-dimensional display.

Semi or fully virtual experiences allowing a user to move around in a (possibly partially) virtual world are becoming increasingly popular and services are being developed to satisfy such a demand.

In some systems, the XR application may be provided locally to a viewer by e.g. a standalone device that does not use, or even have any access to, any remote XR data or processing. For example, a device such as a games console may comprise a store for storing the scene data, input for receiving/generating the viewer pose, and a processor for generating the corresponding images from the scene data.

In other systems, the XR application may be implemented and performed remote from the viewer. For example, a device local to the user may detect/receive movement/pose data which is transmitted to a remote device that processes the data to generate the viewer pose. The remote device may then generate suitable view images and corresponding audio signals for the user pose based on scene data describing the scene. The view images and corresponding audio signals are then transmitted to the device local to the viewer where they are presented. For example, the remote device may directly generate a video stream (typically a stereo/3D video stream) and corresponding audio stream which is directly presented by the local device. Thus, in such an example, the local device may not perform any XR processing except for transmitting movement data and presenting received video data.

In many systems, the functionality may be distributed across a local device and remote device. For example, the local device may process received input and sensor data to generate user poses that are continuously transmitted to the remote XR device. The remote XR device may then generate the corresponding view images and corresponding audio signals and transmit these to the local device for presentation. In other systems, the remote XR device may not directly generate the view images and corresponding audio signals but may select relevant scene data and transmit this to the local device, which may then generate the view images and corresponding audio signals that are presented. For example, the remote XR device may identify the closest capture point and extract the corresponding scene data (e.g. a set of object sources and their position metadata) and transmit this to the local device. The local device may then process the received scene data to generate the images and audio signals for the specific, current user pose. The user pose will typically correspond to the head pose, and references to the user pose may typically equivalently be considered to correspond to the references to the head pose.

In many applications, especially for broadcast services, a source may transmit or stream scene data in the form of an image (including video) and audio representation of the scene which is independent of the user pose. For example, signals and metadata corresponding to audio sources within the confines of a certain virtual room may be transmitted or streamed to a plurality of clients. The individual clients may then locally synthesize audio signals corresponding to the current user pose. Similarly, the source may transmit a general description of the audio environment including describing audio sources in the environment and acoustic characteristics of the environment. An audio representation may then be generated locally and presented to the user, for example using binaural rendering and processing.

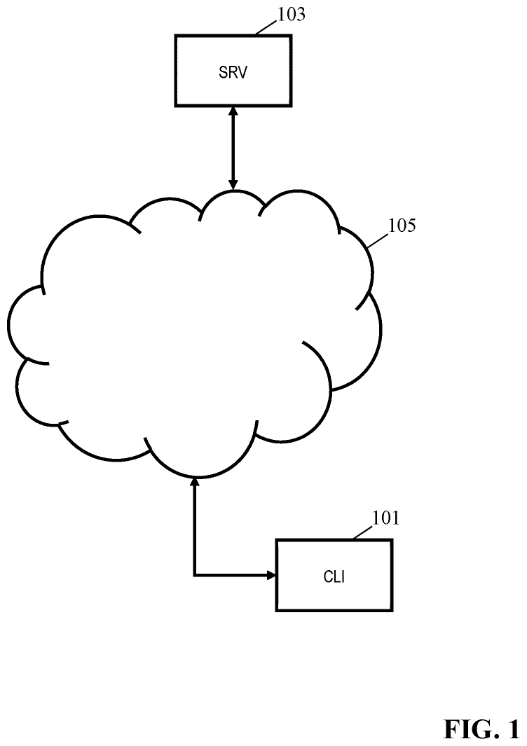

FIG. 1 illustrates such an example of a XR system in which a remote XR client device 101 liaises with a XR server 103 e.g. via a network 105, such as the Internet. The server 103 may be arranged to simultaneously support a potentially large number of client devices 101.

The XR server 103 may for example support a broadcast experience by transmitting an image signal comprising an image representation in the form of image data that can be used by the client devices to locally synthesize view images corresponding to the appropriate user poses (a pose refers to a position and/or orientation). Similarly, the XR server 103 may transmit an audio representation of the scene allowing the audio to be locally synthesized for the user poses. Specifically, as the user moves around in the virtual environment, the image and audio synthesized and presented to the user is updated to reflect the current (virtual) position and orientation of the user in the (virtual) environment.

In many applications, such as that of FIG. 1, it may thus be desirable to model a scene and generate an efficient image and audio representation that can be efficiently included in a data signal that can then be transmitted or streamed to various devices which can locally synthesize views and audio for different poses than the capture poses.

In (fully or partial) virtual environments, such as computer games as well as Augmented Reality (AR) and Virtual Reality (VR) environments, content creators typically aim to provide an immersive experience for the user. Part of this immersion is creating realistic sound effects to mimic the weather or other factors in the users local environment, to match any visual elements.

A good example of this is wind noise that matches the movement of trees, leaves or other objects in the environment. One issue is that wind has no sound of its own, rather it is only the interaction of wind with other objects that creates sounds, such as the movement of tree branches, or the whistling sounds of wind blowing through a ship's rigging (Aeolian tones). One key element of how the listener experiences wind is the sound produced as the air passes over the listeners ears.

As air passes past the ears it causes turbulence within the structures of the ear, this in turn causes the ear drum to vibrate and the person to hear the produced sounds. The level and tonal characteristics of the sound are affected by the speed of the air past the ear, and also the angle that the air passes the listener.

As an example, if you are stood out in the open facing into a strong wind you hear the wind in your ears and you hear the sound change as the strength of the wind changes, but as you turn your head so as not to be facing the wind, the level and spectrum of the sound changes. As another example, if you are cycling on a bike, you can hear the sound due to you passing through the air, but if you turn your head, i.e. to check over your shoulder before turning, the sound changes.

In current approaches, environmental wind noise is generated by adding a pre-recorded or synthesized sound effect. However, such approaches tend to provide a relatively static sound that tends to provide an audio experience which tends to be limited and is often perceived as being relatively unrealistic.

In the following a specific approach for generating an audio signal that includes an improved air flow audio component representing air flow audio in the audio scene will be described. The approach may in particular provide an improved and more realistic audio experience, and in particular may provide an audio signal that may more realistically represent how air flow sounds change dynamically in different scenarios.

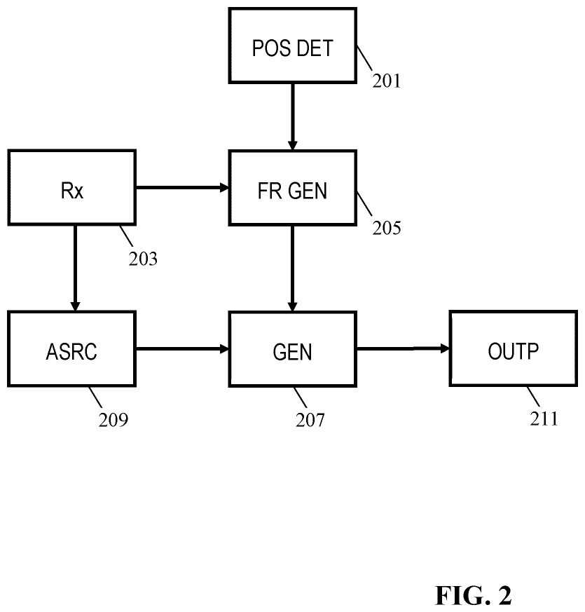

The audio apparatus of FIG. 2 is arranged to generate an audio signal that includes an audio component that represents an air flow, such as a wind noise, for a given listener pose. The audio signal may represent audio of an audio scene with the audio being generated for a listener pose in the audio scene. The air flow audio component may specifically be generated to reflect the specific position and/or orientation and/or velocity of the listener (or more specifically the head of the listener) as well as properties of the air flow itself. In many embodiments, the generated audio signal may in addition to the air flow audio component include a number of other audio components in the output audio signal, such as audio components representing other audio sources in the audio scene.

The audio apparatus comprises a pose determiner 201 which is arranged to determine a listener pose for which the audio signal will be generated.

In the field, the terms placement and pose are used as a common term for position and/or direction/orientation. The combination of the position and direction/orientation of e.g., an object, a camera, a head, or a view may be referred to as a pose or placement. Thus, a placement or pose indication may comprise six values/components/degrees of freedom with each value/component typically describing an individual property of the position/location or the orientation/direction of the corresponding object. Of course, in many situations, a placement or pose may be considered or represented with fewer components, for example if one or more components is considered fixed or irrelevant (e.g. if all objects are considered to be at the same height and have a horizontal orientation, four components may provide a full representation of the pose of an object). In the following, the term pose is used to refer to a position and/or orientation which may be represented by one to six (or even more such as if the orientation is represented by a quaternion or a rotation matrix) values (corresponding to the maximum possible degrees of freedom). The term pose may be replaced by the term placement. The term pose may be replaced by the term position and/or orientation. The term pose may be replaced by the term position and orientation (if the pose provides information of both position and orientation), by the term position (if the pose provides information of (possibly only) position, or by orientation (if the pose provides information of (possibly only) orientation.

The pose determiner 201 may determine a listener pose property that reflects a property of the position and/or orientation of a (nominal/virtual) listener for which the audio signal is generated. The listener pose property is typically provided with reference to the audio scene being presented (e.g. with reference to a scene coordinate system for the audio scene), and specifically for a rendering of a virtual scene the listener pose and property may be with reference to a scene coordinate system for the virtual scene. The property may typically be a pose value or a rate of change value for the pose. Specifically, the pose determiner 201 may in many embodiments be arranged to determine an orientation and/or speed/velocity for the listener, or specifically a head of a listener. In many embodiments, the listener pose property may also (or possibly instead) indicate a position of the listener (or specifically the listener's head).

It will be appreciated that many different approaches for determining and providing a listener/user/viewer pose in a scene/environment are known and that any suitable approach may be used. For example, the second receiver 203 may be arranged to receive pose data from a VR headset worn by the user, from an eye tracker, etc. In other embodiments and applications, a controller or joystick may e.g. be used to control a virtual person/avatar/character in a virtual environment. Such controls are for example well known from computer gaming applications. For example, in a gaming application, a player may control an avatar in a virtual environment using a joystick or other game controller. The corresponding pose (typically both position and orientation) in the virtual environment may be determined and the gaming application may generate a view of the virtual scene which may be presented to the player, e.g. on a monitor or other suitable 2D display. The audio apparatus of FIG. 2 may further use this pose as the listener pose and generate an audio signal that is presented to the user with this audio signal an air flow sound component generated by the audio apparatus of FIG. 2 based on the determined pose (i.e. the pose controlled by the controller is also used as the listener pose).

The audio apparatus further comprises a receiver 203 which is arranged to receive air flow audio frequency profile data that is indicative of a dependency of an air flow audio frequency profile on an air flow velocity parameter. The air flow velocity parameter may specifically be a speed and/or direction of an air flow (typically relative to a listener pose) and the air flow audio frequency profile data may provide information of a frequency distribution/profile of an air flow audio component for different values of the air flow velocity parameter. The air flow audio component may represent the audio perceived by a listener for the given air flow velocity parameter. The air flow audio frequency profile data may typically be provided for a constant nominal/reference listener pose. Equivalently, the air flow velocity parameter may typically be a relative air flow velocity parameter indicative of a relative property of an air flow velocity with respect to a listener pose.

The air flow audio frequency profile data may accordingly provide indications/information of how the frequency distribution of an air flow sound/audio varies with varying values of the air flow velocity parameter, and specifically with varying values of an air flow speed and/or direction (relative to a reference listener pose).

The audio apparatus further comprises a frequency response generator 205 which is coupled to a receiver 203 and the pose determiner 201 and which receives the air flow audio frequency profile data and the listener pose. The frequency response generator 205 is arranged to determine an air flow frequency response in dependence on the air flow audio frequency profile data, the listener pose property, and an air flow velocity property for an air flow. The air flow velocity property may specifically be an air flow speed and/or an air flow direction. For example, the air flow property may indicate the speed and direction of wind in the audio scene. The listener pose property may for example be a position and/or orientation for the listener, and/or may e.g. be a derivative thereof, such as a speed or direction of movement of the listener.

For example, the air flow audio frequency profile data may provide indications of the frequency response for different relative velocities of air flow relative to a listener pose (corresponding to the head of a listener). The air flow velocity property may indicate a direction and speed of the air flow and the listener pose property may indicate the direction and speed of the listener pose/listener's head. The frequency response generator 205 may from these determine the relative speed and direction of the air flow relative to the listener pose/head. It may then access the air flow audio frequency profile data to extract a frequency response provided for a corresponding air flow velocity parameter, i.e. it may extract the frequency profile provided for an air flow velocity parameter that matches the relative speed and direction for the air flow.

The frequency response generator 205 is coupled to an audio component generator 207 which is further coupled to an audio source 209. The audio source 209 provides an audio signal to the audio component generator 207 and the audio component generator 207 is arranged to filter the audio signal based on the air flow frequency response. The audio component generator 207 may specifically generate a filter having a frequency response corresponding to/matching the determined air flow frequency response and apply it to the received audio signal. The filtering may accordingly adapt the audio of the audio signal so that it can more closely reflect the characteristics of the air flow audio that would be perceived by a listener at the listener pose (and with the orientation/velocity represented by the listener pose). The audio component generator 207 accordingly generates an air flow audio signal component by filtering the audio signal from the audio source 209 using the air flow frequency response. It will be appreciated that in some embodiments the audio source 209 may also perform other operations to generate the air flow audio component, such as e.g. an amplitude level setting, other filtering, etc.

In many embodiments, the audio component generator 207 is also arranged to adapt a level of the air flow audio component in response to the (typically relative) air flow velocity parameter. In many embodiments the audio component generator 207 is arranged to adapt a level of the air flow audio component relative to at least one other audio component in the output audio signal, and typically relative to all other audio components. For example, the audio component generator 207 may be arranged to set a level of the air flow audio component as a monotonically increasing function of an air flow speed of the air flow (at the listener pose) relative to the listener pose. Thus, for example, the stronger/faster the wind, the louder the wind noise.

The filtered audio signal is fed to the output generator 211 which generates the audio signal to comprise the air flow audio signal component. In many embodiments, the output generator 211 comprises a mixer/combiner that is arranged to mix/combine different audio components into a single audio signal. For example, audio signal components may be generated for individual audio sources in the audio scene, including e.g. environmental background audio, individual audio point sources, etc. The different audio components may be combined into a single output audio signal that provides a complete rendering of the audio scene with the air flow noise component contributing to the overall perception of the audio source.

The audio apparatus of FIG. 2 is accordingly arranged to receive data from a local or remote source to indicate how a frequency response for air flow audio varies with variations in the listener pose.

In some embodiments, the receiver 203 may be coupled to an internal memory of the auxiliary power provision in which the air flow audio frequency profile data is stored and from which the receiver 101 may be arranged to retrieve the appropriate air flow audio frequency profile data.

For example, the internal memory may comprise a frequency response for a range of different values of one or more pose parameters, such as a frequency response for each of a number of different directions of air flow relative to the listener pose and/or for each of a number of different air flow speeds relative to a listener. Each frequency response may for example be represented by a number of different gain values for different frequencies or by parameter values for a given gain function as a function of frequency.

In such a case, the frequency response generator 205 may be arranged to e.g. determine and extract the stored frequency response for the speed and direction that most closely matches the determined relative air flow velocity.

In many embodiments, the air flow audio frequency profile data may be received from a remote source. For example, the audio apparatus may be part of the client device 103 and the air flow audio frequency profile data may be received from the server 103. The air flow audio frequency profile data may specifically be received in a bitstream including other data describing the audio scene, such as audio data for individual audio sources, position information for such audio sources, background audio data etc. The bitstream may thus provide a representation of the audio scene allowing the client device 103 to render the audio scene. This rendering may include rendering air flow audio/wind noise based on the air flow audio frequency profile data provided in the bitstream.

The approach may thus in particular provide an efficient approach for a content source side control or assistance in how air flow audio should be rendered at the client side while allowing this to be locally adapted to e.g. changes in the listener pose.

In the approach, a frequency response for a filter may be adapted to reflect air flow audio variations due to changes in the air flow relative to a listener. The frequency distribution of a typically locally generated audio signal is modified accordingly, and thus the audio signal is shaped in dependence on the variations in the relative air flow velocity.

In different embodiments, different source audio signals may be used and provided by the audio source 209.

In many embodiments, the audio source 209 may generate the audio signal as a stochastic/pseudorandom signal. In many embodiments, the audio source may be a noise generator generating a noise signal, and in many embodiments, the noise signal may be a white noise signal, or may be a colored noise signal, such as a pink noise signal. Indeed, it has been found that using such noise signals as the basis for the relative air flow velocity dependent coloring by the determined frequency response provides a highly realistic sounding air flow sound in many scenarios and applications.

In some embodiments, the audio source 209 may specifically be a noise source providing an audio signal with a heterogenous mix of frequencies across a given range, or a pink noise having equal energy per octave.

In some embodiments, the audio source 209 may be arranged to generate the audio signal dynamically during operation, and specifically to generate this as a noise signal. However, in other embodiments, the audio signal may be a dedicated audio signal that may e.g. be stored locally. For example, the audio source 209 may comprise a stored recorded wind noise audio signal that may be retrieved and provided to the audio component generator 207.

In many embodiments, the receiver 203 may, e.g. as part of a bitstream providing audio for the audio scene (and e.g. also including the air flow audio frequency profile data), receive an audio signal that is extracted by the audio source 209 and provided to the audio component generator 207 as the audio signal for frequency shaping to generate the air flow audio component.

In some embodiments, such audio signals may e.g. be recorded and stored for different relative velocity values and the audio source 209 may be arranged to extract the one that most closely matches the determined relative velocity property.

Thus, in some embodiments a pre-rendered or recorded piece of audio may be provided for one or more known velocities, and the frequency responses may be determined to reflect relative variations to the frequency distributions of these signals. For example, the determined frequency responses may be designed in such a way as to have a flat response for those known velocities and thus filtering is only applied for other velocities.

In some embodiments, the generated air flow audio component and the audio signal may be single channel signals, i.e. the apparatus may generate a mono audio signal that includes a mono representation of an air flow noise. However, in order to provide an improved user experience with increased spatial perception and a higher degree of externalization, the air flow audio component and the output audio signal are generated as multichannel signals and specifically are generated as stereo signals. The output stereo signal may specifically be a binaural signal which e.g. may be suitable for rendering to a user using headphones.

Thus, in many embodiments, the audio component generator 207 is arranged to generate the air flow audio component to be a stereo air flow audio signal component having two channels. Similarly, the output 211 may generate the audio signal to be a stereo audio signal having two channels. The output 211 may specifically include one channel of the air flow audio component into one channel of the output stereo audio signal, and may include the other channel of the air flow audio component into the other channel of the output stereo audio signal.

The air flow audio component is thus generated to have different signal components for the two channels (henceforth for convenience also referred to as the left and right channel although it will be appreciated that no limitation is intended thereby). The output audio signal is thus also generated to be a stereo signal with different signals in the left and right channel.

In some embodiments, the audio source 209 may generate a stereo audio signal with different signals in the two channels and these signals may be filtered by the same filter/frequency response generated by the frequency response generator 205 to generate an air flow audio component with different signals in the two channels.

In other embodiments, the audio source 209 may generate a mono-signal and the audio component generator 207 may be arranged to apply different filters for the two channels. Thus, in this example, the audio component generator 207 generates the stereo components by different filters being applied.

In many embodiments, the audio source 209 may generate a stereo signal with different channel signals and these may be filtered by the audio component generator 207 using different frequency responses for the two channels. Thus, in this example, the difference between the channels may be caused both by the audio signal used and by different filters being used.

In many embodiments, the air flow audio frequency profile data may include indications of stereo frequency profiles. For example, for each air flow velocity parameter for which data is provided, two frequency responses may be indicated-one for the left channel and one for the right channel. Thus, in many embodiments the frequency response generator 205 may generate two air flow frequency responses with these being applied by the audio component generator 207 for respectively the left and right channel.

In many embodiments, the apparatus may generate the air flow audio signal component to have at least partly decorrelated signals for the two channels. This may specifically be achieved by e.g. the audio source 209 generating pseudo noise signals with a given amount of decorrelation. The decorrelation may specifically assist in providing increased externalization such that the air flow noise is increasingly perceived to be outside the head of the listener.

In some embodiments, the degree of decorrelation may be adapted dependent on the relative air flow velocity. Specifically, the apparatus may be arranged to adapt the degree of decorrelation in dependence on an air flow direction for the air flow relative to the listener. This may for example be achieved by the audio source 209 generating decorrelated signals with the amount of decorrelation being adapted.

Such a variable degree of decorrelation may for example be implemented by introducing a small time offset between the two channels, where the amount of differences controls the degree of decorrelation, or by filtering the two signals with independent all-pass filters constructed to have different phase responses.

In some embodiments, the apparatus may be arranged to vary the degree of decorrelation as a monotonically increasing function of the angular difference between the relative air flow direction and a direction directly ahead of the listener. Thus, the more the relative air flow direction deviates from being from directly in front of the listener, the higher the level of decorrelation.

Such a variable decorrelation may provide a more realistic and immersive experience and may in particular reflect that the more the wind reaches a listener from the side, the more external it tends to be perceived due, in part, to the greater difference between the amplitude levels at the left and right ears. Varying the level of correlation can enhance this effect while maintaining lower sound presentation levels that may be of greater comfort for the listener.

In an exemplary embodiment, air flow audio frequency profile data may for example parameterize an induced air flow noise frequency profile at two or more known velocities and/or e.g. at two or more relative directions (e.g. angles of incidence of the air flow relative to the listener pose). The frequency response generator 205 may specifically determine a velocity vector of the air flow relative to the listener pose in the virtual environment.

The frequency response generator 205 may further determine a noise frequency profile for the relative velocity parameter and proceed to generate an air flow audio component by filtering e.g., a white noise or pink noise audio signal.

In order to generate a sound source that emulates the noise generated within the ear by an air flow over the ear for arbitrary flow velocities, the frequency response generator 205 may generate a target spectrum, and then filter a random noise, such as white noise or pink noise, by that target spectrum. The random noise may typically be a binaural signal, and the interaural correlation may be controlled such that the perceived externalization of the reproduced signal can be modified. However, in some embodiments, the apparatus may not take the pose direction (e.g. head rotation) into account and it may generate only a mono signal and then present the same signal to both ears.

The approach may provide a way to efficiently characterize the relationship between the perceived sound, and the users relative motion through the air, and/or allow content creators to specify a desired sound and how this should change with relative velocities and angles. The actual sound effect to be played back to the user may be generated at the renderer, and as such no additional audio needs to be stored or transmitted from the content creator to the user.

The approach may e.g. provide improved performance by generating the air flow noise audio at an audio renderer in real time while adapting to the relative air flow velocity and the relative direction of air flow with respect to the listener.

The approach may use an efficient method to parameterize the frequency-dependent amplitude changes resulting in different angle-velocity combinations. This is especially useful in the case of a streaming immersive experience where using the minimal possible data is beneficial.

In many embodiments, the air flow audio frequency profile data may include data indicative of how the frequency response depends on an air flow direction parameter and on an air flow speed parameter. Thus, the air flow audio frequency profile data may reflect the dependency on both a relative direction and a relative speed. In many embodiments, the air flow audio frequency profile data may include a frequency response for each of a number of different combined speed and directions. The frequency response generator 205 may in this case extract the frequency response provided for the speed and direction that most closely matches the determined relative air flow speed and direction.

However, in some embodiments, the air flow audio frequency profile data may comprise individual data for the air flow speed and air flow direction. For example, the air flow audio frequency profile data may include a frequency response for each of a plurality of relative air flow directions and in addition include a separate frequency response for each of a plurality of relative air flow speeds.

In such a case, the frequency response generator 205 may be arranged to extract one frequency response for the relative air flow direction most closely matching the determined relative air flow direction for the listener pose. It may further extract one frequency response for the relative air flow direction most closely matching the determined relative air flow speed for the listener pose. The frequency response generator 205 may then generate the frequency response to be used to filter the audio signal from the audio source 209 by combining the two extracted filters. For example, the frequency responses may be considered to correspond to separate sequential filters. Thus, for example, the combined frequency response may be determined e.g. by multiplying normalized frequency gain coefficients.

Thus, in some embodiments, separate frequency responses may be provided for different relative air flow speeds and for different relative air flow directions, and the separate air frequency responses may then be combined into the frequency response to use to filter the audio signal to generate the air flow audio component.

In the previous examples, the air flow audio frequency profile data may provide frequency responses for different values of the air flow velocity parameter and the frequency response generator 205 may be arranged to extract and use the frequency response for the air flow velocity parameter most closely matching the determined relative air flow velocity parameter. However, in some embodiments, the frequency response generator 205 may be arranged to interpolate between frequency responses for the air flow velocity parameter values.

In the situation where two or more frequency responses/spectra are provided by the air flow audio frequency profile data, the interpolation may provide an improved frequency response leading to a more immersive experience and a more realistic perception of the audio scene.

In some such cases, the interpolation method may also be specified e.g. in the air flow audio frequency profile data and/or as part of metadata of a received bitstream characterizing the audio scene. For example, the air flow audio frequency profile data may define that e.g. cubic interpolation should be used. This gives the content creator greater control over how the intermediate target spectra are constructed, while keeping the number of spectra required to a minimum.

In some embodiments, minimum and maximum velocities may also be given, outside of which no interpolation happens, or only the interpolation of specific parameters. In the case that the target spectra are given as filter parameters it may be desirable that only the gain changes beyond some upper velocity threshold, or that only the center frequency and Q change, and not the gain. Likewise, for when specifying frequency-gain pairs, above a certain threshold it may be desirable not to increase the maximum gain any further, but to continue to modify the relative levels between frequencies. (i.e., change the shape of the spectrum, but not the overall level so as to avoid exceeding the maximum level the system can handle).

In some embodiments, the frequency response/target spectrum may be represented by a number of frequency-gain pairs. However, in some embodiments, it may be advantageous to specify the frequency response in terms of a series of band pass filters. For example, each of the known target spectra for a given velocity and/or angle of incidence can be constructed from a series of parametric bandpass filters which can be defined using their center frequency (CF), bandwidth (or Q, where Q=center frequency/bandwidth at −3 dB), and gain (g), plus optionally the order of the filter. Three bandpass filters are typically sufficient to represent the target spectrum, meaning 9 parameters per spectrum to be stored/transmitted, compared to 17 if using ⅓rd Octave spaced frequency-gain pairs for the 20-1000 Hz range shown in FIG. 1. Linear interpolation of the CF, Q and gain values can be used to derive the filters for velocities other than the known ones in the same way as with direct frequency-gain pairs.

The filters may be applied directly to the signal, say as a Butterworth band-pass filter, or the frequency-gain values may be derived for a number of specified frequencies. One method to do this is to solve the quadratic function for each filter, given that the combination of center frequency, Q and gain will give three known frequency-gain values, the polynomial can be calculated.

For any frequency fᵢ the gain gᵢ can be calculated using the quadratic function:

$${g}_{i} = a {f}_{i}^{2} + b {f}_{i} + c$$

$$Where :$$

$$bw = \frac{C F}{Q}$$

$${f}_{1} = C F - ( \frac{b w}{2} ) ; {f}_{2} = C F + ( \frac{b w}{2} )$$

$${g}_{1} = g - 3$$

$$a = \frac{{f}_{1} ( {g}_{1} - g ) + C F ( {g}_{1} - {g}_{1} ) + {f}_{2} ( g - {g}_{1} )}{( {f}_{1} - C F ) ( {f}_{1} - {f}_{2} ) ( C F - {f}_{2} )}$$

$$b = \frac{g - g 1}{C F - {f}_{1}} - a ( C F - {f}_{2} )$$

$$c = {g}_{1} - ( a {f}_{1}^{2} ) - ( b {f}_{1} )$$

In some embodiments, the air flow audio may be generated based on general properties of an air flow present in the audio scene. However, in some embodiments the receiver 203 may be arranged to receive data which describes a property of a source for the air flow for which audio is being generated. The frequency response generator 205 may in such a case proceed to determine the air flow velocity property in dependence on the indicated property of the air flow source.

The air flow source property may specifically indicate a spatial property of an air flow source/generator which generates/causes the air flow. In many embodiments, the air flow source property may specifically indicate a property of the origin of the air flow.

For example, the air flow source property may indicate a spatial extent of the air flow source and specifically may indicate a spatial extent and/or position and/or direction of the air flow generation, such as whether it is a global source with no specific origin, an air flow point source where the air flow originates from a specific point, an omnidirectional air flow source with air flow being generated in all directions, or e.g. a cone air flow source where air flow is generated and a spreading in accordance with a cone shape.

The frequency response generator 205 may proceed to determine the air flow velocity values at the listener position from the air flow source property. Such a calculation/determination may be based on known physical properties, such as known from air flow physics/dynamics. For example, the velocity values may be assumed to decrease by the inverse square law, where the velocity decrease is inversely proportional to square of the distance to the air flow source when the air flow source is a point source, or to decrease proportional to the cross-sectional area of a conic source.

In some embodiments, the data indicating the property of the air flow source may be locally stored or generated. For example, for a game application, the game may locally generate properties reflecting an air source and provide this to the receiver 203. For example, if the game environment includes wind noise, the game application may generate data indicating that a global air flow source is present with a given air flow/wind velocity. If a specific air flow source is present, data may for example be provided that indicates that air flow with a given direction and speed is originating from a specific point in the audio scene.

However, in many embodiments, the receiver 203 may be arranged to receive the indication of the property of the air flow source as part of metadata of an audio bitstream that is received from a remote source. In the example, the client device 101 may specifically receive the air flow source data from the server 103 as metadata in a bitstream describing the audio scene.

The receiver 203 may in this case extract the air flow source property and the frequency response generator 205 may proceed to determine the air flow velocity at the current listener position. It may then determine the relative air flow velocity (relative to the user pose) and use this to determine a suitable frequency response that is then used to determine the air flow audio component as previously described.

The approach may provide a highly efficient and advantageous approach for generating air flow audio and in particular for a remote content side control of such audio. The approach may allow this while keeping a low complexity and low communication overhead.

In many typical applications and audio scenes, air flow may be generated by a number of sources, such as by atmospheric wind, fans, HVAC systems, etc. In order to ensure that the visual objects and the audio scene match well it is desirable to be able to describe the source that generates the air flow, and how it moves within the virtual environment.

One example is to characterize an air flow sources as a global generator or air flow source. Such a global generator may be the simplest form, and may typically best represent sources of air flow such as atmospheric wind. A global source may have no position but has a flow vector (or orientation) and velocity. The received velocity by the user is unaffected by their position within the virtual environment.

An optional region may be specified where the global generator is active, or where it is inactive, which can be used to represent buildings inside which the global generator should not have an effect on the user, but outside of which it does.

As another example, an omnidirectional source may have a position, velocity and an optional distance fade parameter. The flow vector points from the position of the omnidirectional source to the user, irrespective of the user location. The optional distance fade parameter reduces the velocity as distance from the source increases using, for example, the inverse square law.

As another example, a point source may have a position, orientation, azimuth range and elevation range, an optional edge fade parameter, as well as the optional distance fade parameter. The flow vector points from the point source position to the user position but is only active when the vector is within the azimuth and elevation range. The azimuth and elevation range are centered on the frontal direction, and the orientation parameter rotates the point source with respect to the virtual environment.

The edge fade parameter reduces the strength of the velocity as the user approaches the limits of the azimuth or elevation range. It is expressed as a percentage (or value between 0 and 1), where 0% means no fade, and 100% means that the fade starts at the 0° azimuth, 0° elevation angle and fades linearly (or e.g. logarithmically or according to any other curve) to the edge. Other values represent the point at which the fade starts.

As example, considering only azimuth but the same applies to elevation, the azimuthal range is set at 90°, and the edge fade parameter at 50%. A listener positioned at 30° relative to the source has no edge fade applied, a user positioned at 60° relative to the source has a 33% edge fade reduction applied. And a user at 90° has 100% reduction applied.

As yet another example, the air flow audio source may be characterized as a cone/cylinder air flow source. Such a source may have a position, orientation, length, end radius, an optional start radius, as well as the optional edge fade and distance fade parameters. Principally they may act in the same way as a point source, except that the azimuth and elevation edges are calculated based on the length and end radius of the cone. The optional start radius creates a frustum, and the flow vector points from the theoretical tip of the cone towards the user. If start and end radii are the same, then it creates a cylinder, and the flow vector is perpendicular to the axis of the cylinder as defined by the orientation parameter.

In such approaches, the position, orientation, and velocity of the air flow sources may be modifiable. Modifications may be done by the user, by an external source such as a physics engine that is also controlling the visual rendering, or by a random sequence generator.

The content creator may also specify animations of the modifications, such as time-based animations, to switch on and off sources, or move them in a pre-determined sequence.

In the case of velocity or orientation, a pseudorandom sequence may be specified. A desired range and distribution of random values may instead be given and a random number generator used to construct a random sequence that conforms to that range and distribution.

The audio apparatus(s) may specifically be implemented in one or more suitably programmed processors. The different functional blocks may be implemented in separate processors and/or may, e.g., be implemented in the same processor. An example of a suitable processor is provided in the following.

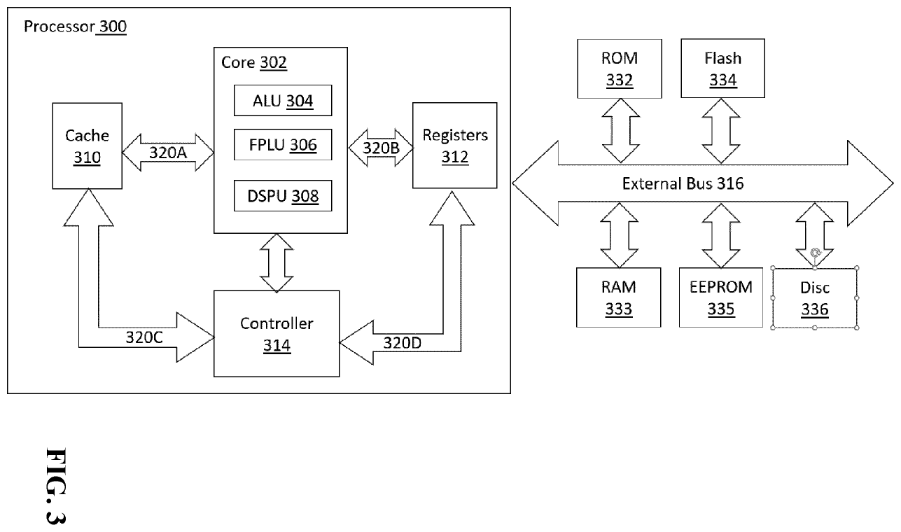

FIG. 3 is a block diagram illustrating an example processor 300 according to embodiments of the disclosure. Processor 300 may be used to implement one or more processors implementing an apparatus as previously described or elements thereof (including in particular one more artificial neural network). Processor 300 may be any suitable processor type including, but not limited to, a microprocessor, a microcontroller, a Digital Signal Processor (DSP), a Field ProGrammable Array (FPGA) where the FPGA has been programmed to form a processor, a Graphical Processing Unit (GPU), an Application Specific Integrated Circuit (ASIC) where the ASIC has been designed to form a processor, or a combination thereof.

The processor 300 may include one or more cores 302. The core 302 may include one or more Arithmetic Logic Units (ALU) 304. In some embodiments, the core 302 may include a Floating Point Logic Unit (FPLU) 306 and/or a Digital Signal Processing Unit (DSPU) 308 in addition to or instead of the ALU 304.

The processor 300 may include one or more registers 312 communicatively coupled to the core 302. The registers 312 may be implemented using dedicated logic gate circuits (e.g., flip-flops) and/or any memory technology. In some embodiments the registers 312 may be implemented using static memory. The register may provide data, instructions and addresses to the core 302.

In some embodiments, processor 300 may include one or more levels of cache memory 310 communicatively coupled to the core 302. The cache memory 310 may provide computer-readable instructions to the core 302 for execution. The cache memory 310 may provide data for processing by the core 302. In some embodiments, the computer-readable instructions may have been provided to the cache memory 310 by a local memory, for example, local memory attached to the external bus 316. The cache memory 310 may be implemented with any suitable cache memory type, for example, Metal-Oxide Semiconductor (MOS) memory such as Static Random Access Memory (SRAM), Dynamic Random Access Memory (DRAM), and/or any other suitable memory technology.

The processor 300 may include a controller 314, which may control input to the processor 300 from other processors and/or components included in a system and/or outputs from the processor 300 to other processors and/or components included in the system. Controller 314 may control the data paths in the ALU 304, FPLU 306 and/or DSPU 308. Controller 314 may be implemented as one or more state machines, data paths and/or dedicated control logic. The gates of controller 314 may be implemented as standalone gates, FPGA, ASIC or any other suitable technology.

The registers 312 and the cache 310 may communicate with controller 314 and core 302 via internal connections 320A, 320B, 320C and 320D. Internal connections may be implemented as a bus, multiplexer, crossbar switch, and/or any other suitable connection technology.

Inputs and outputs for the processor 300 may be provided via a bus 316, which may include one or more conductive lines. The bus 316 may be communicatively coupled to one or more components of processor 300, for example the controller 314, cache 310, and/or register 312. The bus 316 may be coupled to one or more components of the system.

The bus 316 may be coupled to one or more external memories. The external memories may include Read Only Memory (ROM) 332. ROM 332 may be a masked ROM, Electronically Programmable Read Only Memory (EPROM) or any other suitable technology. The external memory may include Random Access Memory (RAM) 333. RAM 333 may be a static RAM, battery backed up static RAM, Dynamic RAM (DRAM) or any other suitable technology. The external memory may include Electrically Erasable Programmable Read Only Memory (EEPROM) 335. The external memory may include Flash memory 334. The External memory may include a magnetic storage device such as disc 336. In some embodiments, the external memories may be included in a system.

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc. do not preclude a plurality. Reference signs in the claims are provided merely as a clarifying example shall not be construed as limiting the scope of the claims in any way.

1. An apparatus comprising:
a receiver circuit,
wherein the receiver circuit is arranged to receive air flow audio frequency profile data,
wherein the air flow audio frequency profile data indicates a dependency of an air flow audio frequency profile on an air flow velocity parameter;
a pose determiner circuit, wherein the pose determiner circuit is arranged to determine a listener pose property for a listener;
a frequency response generator circuit, wherein the frequency response generator circuit is arranged to determine an air flow frequency response based on the air flow audio frequency profile data, the user pose property, and an air flow velocity property of an air flow;
an audio source, wherein the audio source is arranged to provide a first audio signal;
an audio component generator circuit,
wherein the audio component generator circuit is arranged to generate an air flow audio signal component,
wherein the generating of the air flow audio signal components comprises filtering the first audio signal using the air flow frequency response; and
an output circuit, wherein the output circuit is arranged to generate the audio signal so as to comprise the air flow audio signal component.

2. The audio apparatus of claim 1, wherein the frequency response generator circuit is arranged to generate the air flow frequency response based in dependence on an air flow speed for the air flow relative to the listener.

3. The audio apparatus of claim 1, wherein the frequency response generator circuit is arranged to generate the air flow frequency response based in dependence on an air flow direction for the air flow relative to the listener.

4. The audio apparatus of claim 1, wherein the first audio signal is a noise audio signal.

5. The audio apparatus of any previous claim 1,
wherein the audio component generator circuit is arranged to generate the air flow audio signal component to be a stereo air flow audio signal component,
wherein the stereo air flow audio signal component has a first component channel and a second component channel,
wherein the output circuit is arranged to generate the audio signal to be a stereo audio signal,
wherein the stereo audio signal has a first output channel and a second output channel.

6. The audio apparatus of claim 5,
wherein the audio source is arranged to generate the first audio signal to be a stereo audio signal,
wherein the stereo audio signal has different signals in a first source channel and a second source channel.

7. The audio apparatus of claim 5,
wherein the frequency response generator circuit is arranged to generate the air flow frequency response to comprise a first air flow frequency response for the first component channel and a second air flow frequency response for the second component channel,
wherein the audio component generator circuit is arranged to generate a first channel signal component for the air flow audio signal component using the first air flow frequency response for filtering,
wherein the audio component generator circuit is arranged to generate a second channel signal component for the air flow audio signal component using the second air flow frequency response for filtering.

8. The audio apparatus of claim 5, wherein the audio component generator circuit is arranged to generate the air flow audio signal component to have at least partly decorrelated signals for the first component channel and the second component channel.

9. The audio apparatus of claim 5, wherein the audio component generator circuit is arranged to change a degree of decorrelation between the first component channel and the second component channel based on an air flow direction for the air flow relative to the listener.

10. The audio apparatus of any previous claim 1,
wherein the air flow audio frequency profile data comprises an indication of a first dependency of a first air flow audio frequency profile on an air flow direction parameter and an indication of a second dependency of a second air flow audio frequency profile on an air flow speed parameter,
wherein the frequency response generator circuit is arranged to generate a first frequency response in response to the first dependency of the first air flow audio frequency profile on an air flow direction parameter and an air flow direction for the air flow relative to the listener,
wherein the frequency response generator circuit is arranged to generate a second frequency response in response to the second dependency of the second air flow audio frequency profile on an air flow direction parameter and an air flow speed for the air flow relative to the listener,
wherein the frequency response generator circuit is arranged to generate the frequency response as a combination of the first frequency response and the second frequency response.

11. The audio apparatus of claim 1, wherein the audio signal is a stored audio signal.

12. The audio apparatus of claim 1,
wherein the air flow audio frequency profile data comprises an indication of first relative air flow audio frequency response values for each of a plurality of air flow velocity parameter values,
wherein the frequency response generator circuit is arranged to determine second relative air flow audio frequency response values for each of a plurality of interpolated values of the air flow velocity parameter,
wherein the plurality of interpolated values of the air flow velocity parameter comprises interpolation of the plurality of air flow velocity parameter values.

13. The audio apparatus of claim 1,
wherein the receiver circuit is arranged to receive an indication of a property of an air flow source for the air flow,
wherein the frequency response generator circuit is arranged to determine the air flow velocity property in response to the property of the air flow source for the air flow.

14. The audio apparatus of claim 13, wherein
the indication of a property of the air flow source is arranged to indicate the air flow source is at least one of the following:
a global air flow source;
an omnidirectional air flow source;
a point air flow source; and
a cone air flow source.

15. The audio apparatus of claim 13, wherein the receiver circuit is arranged to receive the indication of the property of the air flow source as part of metadata of an audio bitstream received from a remove source.

16. A method comprising:
receiving air flow audio frequency profile data, wherein the air flow audio frequency profile data indicates a dependency of an air flow audio frequency profile on an air flow velocity parameter;
determining a listener pose property for a listener;
determining an air flow frequency response based on the air flow audio frequency profile data, the user pose property, and an air flow velocity property for an air flow;
providing a first audio signal;
generating an air flow audio signal component, wherein the generating of the air flow audio signal components comprises filtering the first audio signal using the air flow frequency response; and
generating the audio signal so as to comprise the air flow audio signal component.

17. A non-transitory computer-readable medium storing a computer program, wherein the computer program when executed on a processor performs the method as claimed in claim 16.

18. The method of claim 16, further comprising generating the air flow frequency response based on an air flow speed for the air flow relative to the listener.

19. The method of claim 16, further comprising generating the air flow frequency response based on an air flow direction for the air flow relative to the listener.

20. The method of claim 16, wherein the first audio signal is a noise audio signal.

21. The method of claim 16, further comprising:
generating the air flow audio signal component to be a stereo air flow audio signal component, wherein the stereo air flow audio signal component has a first component channel and a second component channel; and
generating the audio signal to be a stereo audio signal, wherein the stereo audio signal has a first output channel and a second output channel.

22. The method of claim 21, further comprising generating the first audio signal to be a stereo audio signal, wherein the stereo audio signal has different signals in a first source channel and a second source channel.

23. The method of claim 21, further comprising:
generating the air flow frequency response to comprise a first air flow frequency response for the first component channel and a second air flow frequency response for the second component channel;
generating a first channel signal component for the air flow audio signal component using the first air flow frequency response for filtering; and
generating a second channel signal component for the air flow audio signal component using the second air flow frequency response for filtering.

24. The method of claim 21, further comprising generating the air flow audio signal component to have at least partly decorrelated signals for the first component channel and the second component channel.

25. The method of claim 21, further comprising changing a degree of decorrelation between the first component channel and the second component channel based on an air flow direction for the air flow relative to the listener.

26. The method of claim 16, further comprising:
generating a first frequency response in response to a first dependency of a first air flow audio frequency profile on an air flow direction parameter and an air flow direction for the air flow relative to the listener;
generating a second frequency response in response to a second dependency of a second air flow audio frequency profile on an air flow direction parameter and an air flow speed for the air flow relative to the listener; and
generating the frequency response as a combination of the first frequency response and the second frequency response,
wherein the air flow audio frequency profile data comprises an indication of the first dependency of the first air flow audio frequency profile on an air flow direction parameter and an indication of the second dependency of the second air flow audio frequency profile on an air flow speed parameter.

27. The method of claim 16, wherein the audio signal is a stored audio signal.

28. The method of claim 16, further comprising determining second relative air flow audio frequency response values for each of a plurality of interpolated values of the air flow velocity parameter,
wherein the air flow audio frequency profile data comprises an indication of first relative air flow audio frequency response values for each of a plurality of air flow velocity parameter values,
wherein the plurality of interpolated values of the air flow velocity parameter comprises interpolation of the plurality of air flow velocity parameter values.

29. The method of claim 16, further comprising:
receiving an indication of a property of an air flow source for the air flow; and
determining the air flow velocity property in response to the property of the air flow source for the air flow.

30. The method of claim 29, further comprising receiving the indication of the property of the air flow source as part of metadata of an audio bitstream received from a remove source.
